(19) United States
(12) Patent Application Publication
(10) Pub. No.: US 2014/0207353 A1
(43) Pub. Date: Jul. 24, 2014

(54) ACCELERATION ADJUSTER FOR VEHICLES WITH AN ELECTRONIC ACCELERATOR

(71) Applicants: Stamatios Boulekos, Metamorfosis Attikis (GR); Dimitrios Panagopoulos, Giannitsa Pellas (GR)

(72) Inventors: Stamatios Boulekos, Metamorfosis Attikis (GR); Dimitrios Panagopoulos, Giannitsa Pellas (GR)

(21) Appl. No.: 14/226,340

(22) Filed: Mar. 26, 2014

Related U.S. Application Data
(63) Continuation-in-part of application No. 13/418,946, filed on Mar. 13, 2012, now Pat. No. 8,706,373.
Application No. 13/418,946 is a continuation of application No. 12/094,824, filed on Nov. 17, 2008, now abandoned.

(30) Foreign Application Priority Data
Dec. 9, 2005 (GR) 20050100600

(51) Int. Cl. B60W 30/18

(52) U.S. Cl. CPC B60W 30/18
USPC 701/70

(57) ABSTRACT

An aftermarket amplifier of acceleration signal is mounted between the potentiometer of the acceleration pedal and the electronic control unit and is programmed to control and to modify the signals from the accelerator pedal. The amplifier improves the acceleration of a car and overcomes the problems occurring during overreacting. The amplifier measures the signals from the acceleration pedal, calculates the change of the angle of the potentiometer of acceleration speed (angular speed) and multiplies the signals from the acceleration pedal by a value which is determined by the angular speed of the potentiometer of the accelerator pedal. Additionally, the amplifier includes a function of a cruise control, which can be controlled with a single control switch.

### RELATED APPLICATIONS

This application is a continuation-in-part of co-pending U.S. patent application Ser. No. 13/418,946, filed on Mar. 13, 2012 by the same inventors, which is a continuation of U.S. patent application Ser. No. 12/094,824, filed Nov. 17, 2008 by the same inventors, which is a 35 U.S.C. §371 application of International Application No. PCT/GROG/00065, filed Nov. 28, 2006 by the same inventors and published in English, and claims priority to Greek Application No. GR 20050100600, filed by the same inventors in Greece on Dec. 9, 2005. Each of the above-referenced applications is incorporated by reference herein in its entirety.

### BACKGROUND OF INVENTION

1. Field of the Invention

The invention refers to a system of continuous measurements and transformations of signals which come from the potentiometer of an electronic acceleration pedal of a modern car.

2. Background

Lately there has been an increase in the complaints of drivers of new technology cars having an electronic acceleration pedal, concerning the lack of acceleration response to the driver's orders.

In new technology cars, the command of acceleration is not transmitted with the traditional wire (the mechanical way). Instead, the command is transmitted from the driver's foot to the electronic control unit (ECU) with a potentiometer (electronic acceleration pedal).

The application of the electronic acceleration pedal has resulted in bad acceleration of the car and the problems caused in the overacting and generally the circulation of vehicles.

### SUMMARY OF THE INVENTION

This invention is designed to cover the disadvantage of poor acceleration of cars that have an electronic acceleration pedal.

The basic operation of the amplifier of acceleration signals for new technology cars is the digital transformation of the signals of the potentiometer with proper software and their transmission to the control unit.

Simultaneously with the transformation of acceleration signals, the device also executes a second operation, which is to maintain a steady speed when a switch is pressed by the driver (automatic pilot/cruise control).

The amplifier of acceleration signals for new technology cars has as a basic item a microprocessor which is programmed to measures the signals from the acceleration potentiometer, and supply the ECU with new signals which will improve the acceleration of the vehicle and will keep the speed of the vehicle steady during long travels, when it is chosen by the driver.

The invention is fully applied as it refers to changing of the signals of the electronic acceleration pedal, and it does not alter the structure of the central program of the car.

One more advantage of the device is the possibility of its inactivation by pressing a switch on the car board (grounding command).

In an exemplary embodiment, the circuitry changes the signals of the electronic acceleration pedal by multiplying the signals by an amount that is functionally dependent on the rate of change in position of the electronic accelerator. In other exemplary embodiments the amount is functionally dependent on the angular speed of the electronic accelerator. In other exemplary embodiments, the amount is proportional to the angular speed of the electronic accelerator. In other exemplary embodiments, the amount increases by a factor of F over a default value, e.g. 1.0, when the angular speed increases by a factor of G over a threshold value of the angular speed, e.g. 30°/sec, wherein F=c*G, where c is a pre-defined constant. In an exemplary embodiment, the constant can be adjusted by the user, e.g. an operator of a vehicle. In another exemplary embodiment, the constant is determined based on at least one input signal from the user.

In another exemplary embodiment, the amount is substantially dependent on the rate of change in position of said electronic accelerator, but substantially independent of an absolute position of said electronic accelerator. In some embodiments the amount is substantially independent of one single absolute position of the electronic accelerator, but substantially dependent on the difference between two absolute positions of the electronic accelerator.

In another exemplary embodiment, the amount can be varied by a user in order to obtain variable ratios of a second value represented by the output signals to a first value represented by the input signals. In some exemplary embodiments, the first value and/or the second value may be represented using a pulse-width-modulated voltage.

In another exemplary embodiment, the input signals represent at least a first value and the output signals represent at least a second value. In other exemplary embodiments the input signals and/or the output signals may represent one or more additional values. In other exemplary embodiments, any of these values may be represented using a pulse-width-modulated voltage.

In another exemplary embodiment, the step of multiplying the input signals comprises multiplying the first value by the amount to obtain the second value. In some exemplary embodiments, the amount is a factor G of the current angular speed over a threshold value of the angular speed, e.g. 30°/sec, multiplied by d, where d is a pre-defined constant. In an exemplary embodiment, the constant d can be adjusted by the user, e.g. an operator of a vehicle.

### BRIEF DESCRIPTION OF THE DRAWINGS

The invention is presented below with reference to the following drawings.

FIG. 1A is a side view showing the outer appearance and exterior dimensions of a device according to one embodiment of the present invention.

FIG. 1B is a top view of the device of FIG. 1A.

FIG. 2 is a diagram showing one embodiment of the electronic circuit of the amplifier of acceleration signals-auto pilot, for new technology cars according to the present invention.

FIG. 3 shows a control unit for allowing a user to vary an amount in order to obtain variable ratios of a second value represented by the output signals to a first value represented by the input signals.

### DETAILED DESCRIPTION

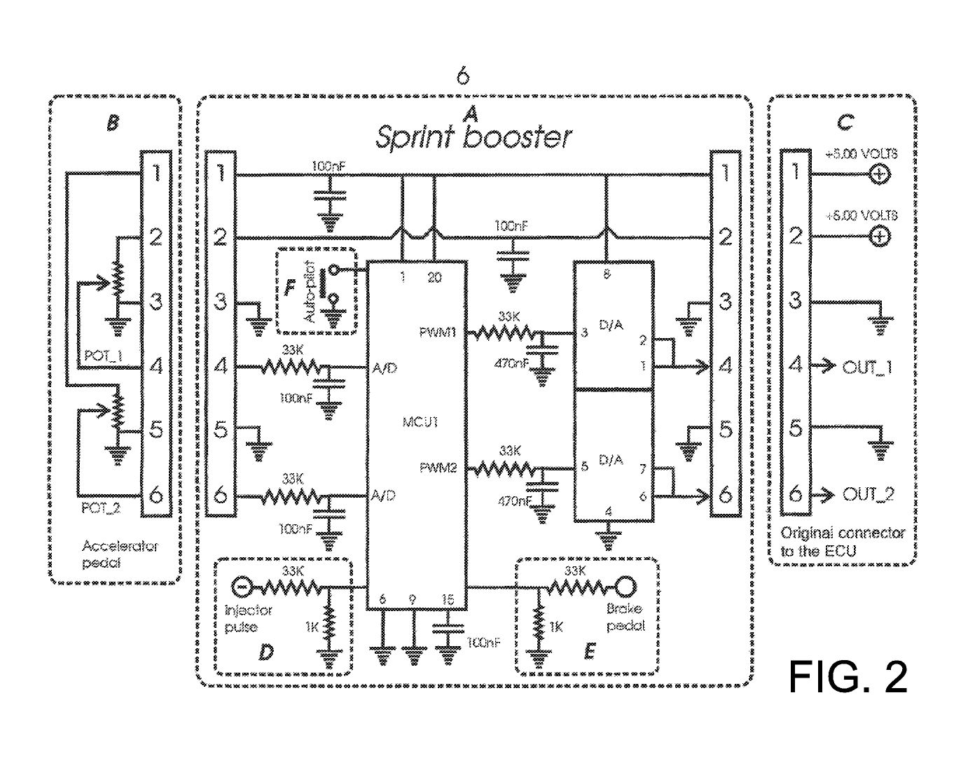

The signals from the acceleration potentiometer (FIG. 2, box B) are smoothed and directed to the A/D input of the microprocessor. As will be described below, the microprocessor provides a means for determining a rate of change in position of the electronic accelerator. The microprocessor also provides a means for generating output signals by multiplying the input signals by an amount that is functionally dependent on the rate of change in position of the electronic accelerator.

The microprocessor (FIG. 2, box A) is programmed to measure the signals from the acceleration pedal with priorities, and to calculate the change of the angle of the potentiometer of the acceleration pedal (the angular speed of acceleration pedal). Then the program multiplies the signal's rates by an algorithm which is determined by the rate of the angular speed of the acceleration potentiometer.

The signals at the entry of the microprocessor are compared between each other as well as the altered signals at the exit of the microprocessor. Another algorithm oversees the comparisons of the signals and decides whether the entry signals and their transformations should be accepted before being sent to the exit the device.

As long as the device is interfaced between the acceleration potentiometer (FIG. 2, box B) and the electronic control unit (ECU) (FIG. 2, box C) it is possible for the device to under-take complete control of the car's speed as it is asked by the driver.

When the car develops some speed, e.g. 80 km/hour, then if the driver presses the auto-pilot switch (FIG. 2, box F), the program reads the command and waits for the driver to leave the acceleration pedal within the next five seconds (confirmation of auto pilot order).

If the program recognizes these two conditions (switch and pedal), then it will enable the operation of the automatic pilot.

Now the microprocessor does not alter the signals of the electronic acceleration pedal, but it reads the RPM of the engine and increases or decreases the commands to the ECU with final result to keep the RPM of the engine steady as well as the speed of the car, without the driver having to press the acceleration pedal.

The pulses from the injectors (FIG. 2, box D) are used for the calculation of the engine revolving speed (RPM) during the operation of the automatic pilot.

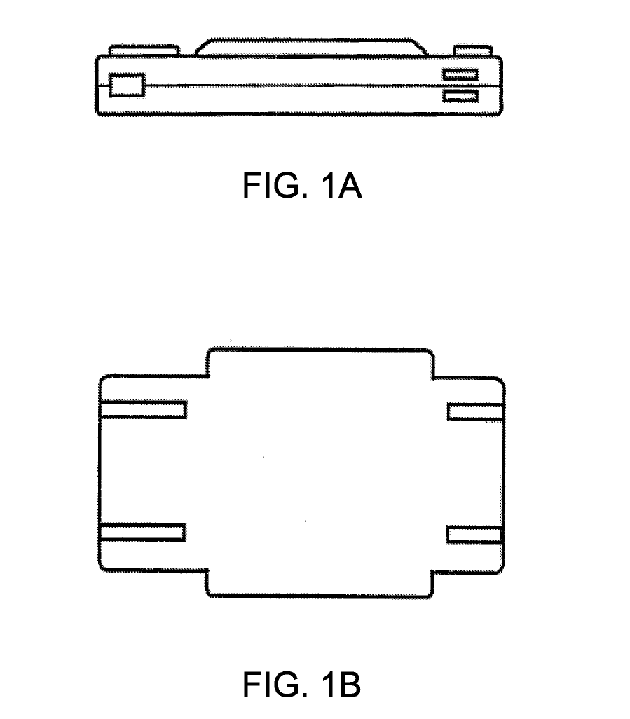

In order to take the program out of auto pilot operation, one of the following should be done: the driver should either press the brake pedal (FIG, 2, box E), or press acceleration pedal again, (FIG. 1, box B).

The amplifier of acceleration signals and auto pilot (FIG. 2, box A), is attached between the potentiometer of the acceleration pedal (FIG. 2, box B) and the ECU (FIG. 2, box C).

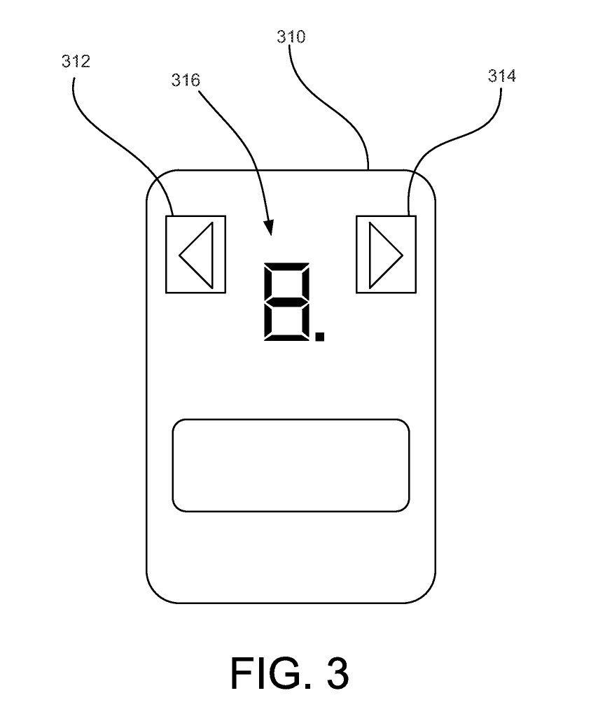

FIG. 3 shows a control unit 310 for allowing a user to vary the amount in order to obtain variable ratios of a second value represented by the output signals to a first value represented by the input signals. By pressing a first button 312, the amount is reduced. By pressing a second button 314, the amount is increased. An indicator 316 shows the user a number which represents the current level setting of the amount. Other indicators, including LEDs or LCD-displays may be used alternatively or in addition.

Control unit 310 generates user input signals based on the input from the user and provides the user input signals to the microprocessor (FIG. 2, box A) via a wired or wireless connection (not shown). The microprocessor then determines the amount based at least in part on the user input signals and/or the current rate of change in position of said electronic accelerator (FIG. 2, box B).

The system is completed in a device which is placed in the interior of the car and is attached to the connector of the acceleration pedal.

The designing of the device allows its easy installation in all models in a simple way, without needing to get into the electronic circuits of the car. (Is not influenced the operation of circuits of the car, e.g., injection system-ignition system, ABS etc.).

We claim:

1. A retrofit device for a vehicle with an electronic accelerator and an electronic control unit, said retrofit device for improving the acceleration of said vehicle, said retrofit device comprising:
a first connector configured to be connected to said electronic accelerator and configured to accept input signals from said electronic accelerator, said input signals indicating a position of said electronic accelerator;
a second connector configured to be connected to said electronic control unit and configured to provide output signals to said electronic control unit, said output signals indicating a transformed position of said electronic accelerator;
circuitry electrically coupled to said first and second connectors, said circuitry configured
to receive said input signals,
to send said output signals,
to calculate a rate of change in position of said electronic accelerator based on said input signals, and
to generate said output signals by multiplying said input signals by an amount; and wherein
said retrofit device is configured to be installed in said vehicle by connecting said first connector to said electronic accelerator and connecting said second connector to said electronic control unit.

2. The retrofit device of claim 1, wherein the amount is functionally dependent on said rate of change in position of said electronic accelerator.

3. The retrofit device of claim 1, wherein the amount is substantially dependent on said rate of change in position of said electronic accelerator, but substantially independent of an absolute position of said electronic accelerator.

4. The retrofit device of claim 1, further comprising:
a user input device configured to generate user input signals responsive to interaction with a user; and wherein
said circuitry responsive to said user input signals is operative to vary the amount in order to obtain variable ratios of a second value represented by the output signals to a first value represented by the input signals.

5. The retrofit device of claim 1, wherein said input signals represent at least a first value and wherein said output signals represent at least a second value.

6. The retrofit device of claim 1, wherein the step of multiplying said input signals comprises multiplying said first value by said amount to obtain said second value.

7. The retrofit device of claim 1, wherein:
said input signals comprise a first input signal and a second input signal;
said first and second input signals occur substantially concurrently;
said output signals comprise a first output signal and a second output signal;
said first and second output signals occur substantially concurrently; and
said circuitry is further configured
to perform a first comparison on said first and second input signals with each other,
to perform a second comparison on said first and second output signals with each other, and
to decide, based on said first and second comparisons, whether said input signals and said output signals should be accepted before being sent to said electronic control unit.

8. The retrofit device of claim 1, wherein:
said input signals comprise a first input signal and a second input signal;
said first and second input signals occur substantially concurrently; and
said circuitry is configured to process said first and second signals substantially concurrently and independently from each other.

9. The retrofit device of claim 1, wherein said electronic accelerator includes an accelerator pedal.

10. The retrofit device of claim 1, wherein:
said input signals indicate an actual angle of said electronic accelerator;
said output signals indicate a transformed angle of said electronic accelerator; and
said circuitry is configured to
calculate an angular speed of said electronic accelerator based on said input signals, and
generate said output signals by multiplying said input signals by an amount that is functionally dependent on said angular speed.

11. The retrofit device of claim 1, wherein said retrofit device is configured to be installed in said vehicle without modifying said electronic control unit.

12. The retrofit device of claim 1, wherein said vehicle is a car.

13. A vehicle having an electronic accelerator with a first connector, an electronic control unit with a second connector, and an acceleration adjuster, said acceleration adjuster comprising:
a third connector complementary to said first connector, said third connector configured to accept input signals from said electronic accelerator, said input signals indicating an actual position of said electronic accelerator;
a fourth connector complementary to said second connector, said fourth connector configured to provide output signals to said electronic control unit, said output signals indicating a transformed position of said electronic accelerator; and
circuitry electrically coupled to said third connector and said fourth connector, said circuitry configured
to receive said input signals from said third connector,
to provide said output signals to said fourth connector,
to calculate a rate of change in position of said electronic accelerator based on said input signals, and
to generate said output signals by multiplying said input signals by an amount that is functionally dependent on said rate of change in position of said electronic accelerator; and wherein
said first connector is connected to said third connector;
said second connector is connected to said fourth connector; and
said second connector is complementary to and adapted to engage said first connector.

14. The vehicle of claim 13, wherein the amount is functionally dependent on said rate of change in position of said electronic accelerator.

15. The vehicle of claim 13, wherein the amount is substantially dependent on said rate of change in position of said electronic accelerator, but substantially independent of an absolute position of said electronic accelerator.

16. The vehicle of claim 13, further comprising:
a user interface operative to generate user input signals responsive to interaction with a user; and wherein
said circuitry responsive to said user input signals is operative to vary the amount to obtain user selected ratios of a second value represented by the output signals to a first value represented by the input signals.

17. The vehicle of claim 13, wherein said input signals represent at least a first value and wherein said output signals represent at least a second value.

18. The vehicle of claim 13, wherein the step of multiplying said input signals comprises multiplying said first value by said amount to obtain said second value.

19. The vehicle of claim 13, wherein:
said input signals comprise a first input signal and a second input signal;
said first and second input signals occur substantially concurrently;
said output signals comprise a first output signal and a second output signal;
said first and second output signals occur substantially concurrently; and
said circuitry is further configured
to perform a first comparison on said first and second input signals with each other,
to perform a second comparison on said first and second output signals with each other, and
to decide, based on said first and second comparisons, whether said input signals and said output signals should be accepted before being sent to said electronic control unit.

20. The vehicle of claim 13, wherein:
said input signals comprise a first input signal and a second input signal;
said first and second input signals occur substantially concurrently; and
said circuitry is configured to process said first and second signals substantially concurrently and independently from each other.

21. The vehicle of claim 13, wherein said electronic accelerator includes an accelerator pedal.

22. The vehicle of claim 13, wherein:
said input signals indicate an actual angle of said electronic accelerator;
said output signals indicate a transformed angle of said electronic accelerator; and
said circuitry is configured to
calculate an angular speed of said electronic accelerator based on said input signals, and
generate said output signals by multiplying said input signals by an amount that is functionally dependent on said angular speed.

23. The vehicle of claim 13, wherein said acceleration adjuster is configured to be installed in said vehicle without modifying said electronic control unit.

24. The vehicle of claim 13, wherein said vehicle is a car.

25. A retrofit device for a vehicle with an electronic accelerator and an electronic control unit, said retrofit device for improving the acceleration of said vehicle, said retrofit device comprising:
a first connector configured to be connected to said electronic accelerator and configured to accept input signals from said electronic accelerator, said input signals indicating an actual position of said electronic accelerator;
a second connector configured to be connected to said electronic control unit and configured to provide output signals to said electronic control unit, said output signals indicating a transformed position of said electronic accelerator;
a user interface configured to receive input from a user and to generate user input signals indicative of particular ratios of a second value represented by the output signals to a first value represented by the input signals
means for determining a rate of change in position of said electronic accelerator; and
means for generating said output signals based on said input signals, said user input signals, and said rate of change in position of said electronic accelerator.
